(19) United States
(12) Patent Application Publication
(10) Pub. No.: US 2024/0427055 A1
(43) Pub. Date: Dec. 26, 2024

(54) Meta surface manufacturing apparatus, manufacturing method and meta surface using nanocomposite

(71) Applicant: POSTECH, Pohang-si (KR)

(72) Inventor: Jun Suk RHO, Pohang-si (KR)

(21) Appl. No.: 18/569,686

(22) PCT Filed: Dec. 30, 2021
(86) PCT No.: PCT/KR2021/020267

§ 371 Date: Aug. 26, 2024

(30) Foreign Application Priority Data
Jun. 23, 2021 (KR) 10-2021-0081278
Dec. 29, 2021 (KR) 10-2021-0191161

(51) Int. Cl. G02B 1/00; B82Y 30/00; B82Y 40/00

(52) U.S. Cl. CPC G02B 1/002; B82Y 30/00; B82Y 40/00

(57) ABSTRACT

A meta surface manufacturing apparatus, manufacturing method, and meta surfaces using nanocomposite, and more specifically, a meta surface manufacturing apparatus, manufacturing method, and meta surface for manufacturing meta surface which are formed to have a high refractive index and may effectively refract even low wavelength light. According to one aspect of the present disclosure, there may be provided a meta surface manufacturing apparatus including a soft mold with a surface formed with a plurality of embossed portions and engraved portions and a nanocomposite applied to the surface of the soft mold, wherein the nanocomposite includes resin formed of a thermosetting material and nanoparticles mixed in the resin, wherein the nanoparticles may be provided as one of zirconium dioxide (ZrO2), silicon (Si), or titanium dioxide (TiO2).

### TECHNICAL FIELD

The present disclosure relates to a meta surface manufacturing apparatus, manufacturing method, and meta surface using nanocomposites, and more specifically, relates to a device and method for manufacturing a meta surface that is formed to have a high refractive index and can effectively refract light of low wavelengths, and a meta surface produced thereby.

### BACKGROUND

Metalens refer to lens manufactured by processing materials into a meta surface. The meta surface is formed by regularly arranged nanoparticles of 50 nm in size. Compared to lenses made of transparent materials such as existing glass, metalens have improved light transmittance and refractive index and can reduce their size and thickness, so they have recently been used in various types of smart devices.

A meta surface is formed by arranging nanostructures smaller than the wavelength of light. Therefore, due to the small size, it is difficult to manufacture using commonly used UV (Ultra Violet) lithography, so the meta surface is generally manufactured using electron beam lithography.

However, in the case of electron beam lithography, a very long time is required to produce the meta surface. Therefore, in terms of process efficiency and production efficiency, there are limits to mass producing large-area meta surface.

In particular, a meta surface that operates in the ultraviolet (UV) region requires smaller nanostructures than nanostructures that operate in the visible light region, and in order to manufacture a meta surface that operates in the ultraviolet (UV) region, an electron beam lithography with higher resolution is needed. That is, using the electron beam lithography to produce a meta surface that operates in the ultraviolet (UV) region has the disadvantage of being expensive.

In addition, in order to realize a high efficiency meta surface that operates in the ultraviolet (UV) region, it is necessary to have less absorption in the UV region, but gallium nitride, which has been used as a material for meta surface in the past, has a very small bandgap, so it absorbs all of the energy in the UV region, resulting in a decrease in transmission efficiency.

### SUMMARY

An object of the present disclosure is to provide a meta surface manufacturing apparatus, manufacturing method, and meta surface using nanocomposites that can solve the above-mentioned problems.

First, it is an object to provide a meta surface that can secure a high refractive index while improving the efficiency and economic feasibility of the process, meta surface manufacturing apparatus 10 and manufacturing method.

Further, it is an object to provide a meta surface with a high refractive index and a low extinction coefficient in the ultraviolet (UV) region, a meta surface manufacturing apparatus for manufacturing the meta surface, and a manufacturing method.

Further, it is an object to provide a meta surface configured to refract various components of light according to wavelength, a meta surface manufacturing apparatus for manufacturing the meta surface, and a manufacturing method.

Further, it is an object to provide a meta surface configured to minimize the degree of scattering of incident light, a meta surface manufacturing apparatus for manufacturing the meta surface, and a manufacturing method.

A meta surface manufacturing apparatus comprising a soft mold with a surface on which a plurality of embossed portions and engraved portions are formed; a nanocomposite applied on the surface of the soft mold, wherein the nanocomposite comprises resin formed of a thermosetting material; and nanoparticles mixed in the resin, wherein the nanoparticles may be provided as one of zirconium dioxide (ZrO2), silicon (Si), or titanium dioxide (TiO2).

Further, the soft mold comprises a first layer which forms the surface and is where the nanocomposite is applied; and a second layer coupled to the first layer and disposed opposite to the surface; wherein a material forming the first layer is less viscous and more rigid than a material forming the second layer.

Further, a meta surface manufacturing apparatus may be provided wherein the first layer is formed with h-PDMS (hard polydimethylsiloxane) material, and the second layer formed with polydimethylsiloxane (PDMS) material.

Further, a meta surface manufacturing apparatus may be provided comprising a hard mold with a surface on which the plurality of concave portions and convex portions disposed complementary to the plurality of embossed portions and engraved portions are formed, and the plurality of embossed portions and engraved portions formed on the surface of the soft mold are formed by the plurality of convex portions and concave portions formed on the surface of the hard mold through replicating.

Further, a meta surface manufacturing apparatus may be provided comprising a support layer which is in contact with the surface of the soft mold and in which the nanocomposite applied on the surface of the soft mold is seated.

According to another embodiment of the present disclosure, a meta surface manufactured according to the meta surface manufacturing apparatus may be provided comprising a nanostructure formed by curing the nanocomposite.

Further a meta surface may be provided wherein the nanostructure comprises a nano base forming the base of the nanostructure and formed in a plate-like form; and nano columns protruding from the nano base.

Further, a meta surface may be provided wherein the nano columns are provided in a plurality, and the plurality of the nano columns are spaced apart from each other.

According to another embodiment of the present disclosure, there may be provided a meta surface manufacturing method comprising: a step (a) in which a plurality of embossed portions and engraved portions are formed on the surface of a soft mold; a step (b) in which nanocomposite is applied onto the surface of the soft mold; a step (c) in which the applied nanocomposite is printed on a support layer; and a step (d) in which the printed nanocomposite is formed into a nanostructure, wherein the nanocomposite comprises resin formed of a thermosetting material; and nanoparticles mixed in the resin, wherein the nanoparticles may be provided as one of zirconium dioxide (ZrO2), silicon (Si), or titanium dioxide (TiO2).

Further, a meta surface manufacturing method may be provided wherein the step (a) comprises: a step (a1) in which a first layer and a second layer are laminated; a step (a2) in which the first layer is pressed onto a hard mold; and a step (a3) in which the plurality of embossed portions and engraved portions are formed on the surface of the first layer complementary to the plurality of concave portions and convex portions.

Further, a meta surface manufacturing method may be provided wherein the step (b) comprises a step (b1) in which the plurality of nanoparticles are injected into the resin to form the nanocomposite; a step (b2) in which the injected nanoparticles are dispersed and distributed; And a step (b3) in which the nanocomposite is applied on the plurality of embossed portions and engraved portions formed on the surface of the soft mold.

Further, a meta surface manufacturing method may be provided wherein the step (c) comprises: a step (c1) in which the nanocomposite is combined with the support layer; and a step (c2) in which the combined nanocomposite is pressured and heated.

Further, a meta surface manufacturing method may be provided wherein the step (d) comprises: a step (d1) in which the combined nanocomposite is cured and forms a nano base combined with the support layer, and a plurality of nano columns protruding towards the soft mold; and a step (d2) in which the nanocomposite combined to the support layer and the nanocomposite are separated.

According to an embodiment of the present disclosure, the following effects can be achieved.

First, a nanostructure comprises resin and a plurality of nanoparticles that are mixed within resin. Here, the nanoparticles may be provided as zirconium dioxide (ZrO2) particles. In this case, a meta surface formed from the nanoparticles comprising zirconium dioxide (ZrO2) may have a refractive index from 1.7 to 2.1 (preferably 2), and an extinction coefficient from 0.01 to 0.1.

Further, the nanoparticles may be provided as silicon (Si) or titanium dioxide (TiO2). In particular, a meta surface comprising the nanoparticles formed from silicon (Si) may have a refractive index in the visible light region (wavelength 532 nm) of 2.38 or more, thereby increasing the refractive index of the nanostructure and the nanostructure comprising the same.

Therefore, the refractive index of the meta surface comprising the nanoparticles may be secured above a predetermined standard value, and high transmission efficiency may be exhibited.

Further, a high refractive index may be secured by the material properties of the nanostructure, so excessive structural changes of the nanostructure are not required to secure a high refractive index. For example, even if the aspect ratio of the nano columns constituting the nanostructure is low, a sufficient refractive index to refract light may be secured.

In addition, the nanostructures are manufactured through a soft mold composed of at least two materials with different mechanical rigidity and viscosity. The soft mold comprises a first layer having relatively high mechanical rigidity and low viscosity and a second layer supporting the first layer.

A nanocomposite for forming a nanostructure is applied on the first layer to cover the first layer. Therefore, the nanostructure and the soft mold formed after the nanocomposite is cured by heat or pressure may be easily separated.

In addition, even if the soft mold is combined with the hard mold and heat or pressure is applied to replicate the shape of the nanostructure, shape deformation of the soft mold may be minimized.

As a result, even if the structure of the nanostructure is simply formed, a high refractive index may be secured, thereby improving the efficiency and economic feasibility of the manufacturing process. Furthermore, the soft mold may be used a plurality of times, eliminating the need to create a new mold each time a nanostructure is manufactured, which also improves the efficiency and economic feasibility of the manufacturing process.

In addition, as zirconium dioxide (ZrO2) or silicon (Si) material is applied as nanoparticles, curing of the nanocomposite is carried out by heating. Therefore, compared to the case of curing using UV, curing of the nanocomposite by heating may be carried out evenly and uniformly.

In addition, when silicon (Si) material is applied as nanoparticles, the manufactured nanostructure and the meta surface manufactured using the same may secure a high refractive index not only in the visible light region but also in the infrared region (wavelength 940 nm).

Consequently, the scattering degree of light incident on the manufactured meta surface may be minimized.

### BRIEF DESCRIPTION OF DRAWINGS

FIG. 1 is a block diagram showing the configuration of a meta surface manufacturing apparatus according to an embodiment of the present disclosure.

FIG. 2 shows a conceptual view of the flow of a meta surface manufacturing method using the meta surface manufacturing apparatus of FIG. 1.

FIG. 3 shows the surface of the hard mold (a), the surface of the soft mold (b), and the surface of the manufactured nanostructure (c).

FIG. 4 is a flowchart showing the flow of the meta surface manufacturing method according to the embodiment of the present disclosure.

FIG. 5 is a flowchart showing step S100 of the meta surface manufacturing method of FIG. 4.

FIG. 6 is a flowchart showing step S200 of the meta surface manufacturing method of FIG. 4.

FIG. 7 is a flowchart showing step S300 of the meta surface manufacturing method of FIG. 4.

FIG. 8 is a flowchart showing step S400 of the meta surface manufacturing method of FIG. 4.

FIG. 9 is a graph showing the refractive index and extinction coefficient according to the wavelength of light transmitting through when the nanoparticles of the nanostructure are zirconium dioxide (ZrO2) particles.

FIG. 10 is a graph showing the refractive index and extinction coefficient according to the wavelength of light transmitting through when the nanoparticles of the nanostructure are silicon (Si) particles.

FIG. 11 is a graph showing the refractive index and extinction coefficient according to the wavelength of the light passing through when the nanoparticles of nanostructure 500 are titanium dioxide (TiO2) particles.

FIG. 12 is an enlarged view showing a nanocomposite in which nanoparticles are silicon (Si) in an embodiment of the present disclosure.

FIG. 13 is a graph showing the polarization change (a), refractive index (n), and extinction coefficient (k) (b) of light irradiated to the nanocomposite containing silicon (Si) of FIG. 12.

FIG. 14 is a graph showing the transmittance and phase of the nano column measured using Rigorous Coupled-Wave Analysis (RCWA) and Finite-Difference Time-Domain (FDTD) methods.

FIG. 15 is a graph showing the strength of the magnetic field according to the diameter of the nano column.

FIG. 16 is a graph showing the results of a beam-steering simulation illustrating the phase change of light per single nanocolumn.

FIG. 17 is a graph showing a phase change in the space required for metalens with a meta surface according to an embodiment of the present disclosure.

FIG. 18 is a graph showing the intensity of the optical field passing through metalens with a meta surface according to an embodiment of the present disclosure.

FIG. 19 shows metalens including a meta surface manufactured by a meta surface manufacturing method according to an embodiment of the present disclosure.

FIG. 20 is a graph showing an image generated by metalens comprising a meta surface according to an embodiment of the present disclosure.

FIG. 21 is a graph showing the intensity (a) of a cross-section at the center of the focus of an image generated by metalens comprising a meta-surface according to an embodiment of the present disclosure, and a comparison result of the intensity of the diffraction-limited metalens with a modulation transfer function (MTF).

FIG. 22 is a diagram showing images acquired using different aperture diameters.

FIG. 23 is a diagram illustrating an image acquired using an optimized aperture diameter in the example of FIG. 22.

### DETAILED DESCRIPTION OF EXEMPLARY EMBODIMENTS

Hereinafter, the meta surface manufacturing apparatus 10, manufacturing method, and meta surface using nanocomposite according to embodiments of the present disclosure will be described in detail with reference to the attached drawings. In the description below, the description of some elements may be omitted to clarify the characteristics of the present disclosure.

### 1. Definition of Terms

When an element is referred to be “connected” or “coupled” to another element, it should be understood that it may be directly connected or coupled to that other element, but there may be other elements in between.

On the other hand, when an element is stated to be “directly connected” or “directly coupled” to another element, it should be understood that there is no other elements in between. The singular expressions in the present specification may encompass plural expressions unless clearly specified otherwise in context.

### 2. Description of the Configuration of Meta Surface Manufacturing Apparatus 10 According to the Embodiment of the Present Disclosure

Meta surface manufacturing apparatus 10 according to an embodiment of the present disclosure utilizes nanocomposites to overcome the limitations of metalens according to the prior art. Nanocomposites are synthesized by dispersing nanoparticles in a printable resin using heat or pressure. At this time, the resin may be cured by heat or ultraviolet rays.

Accordingly, the meta surface manufacturing apparatus 10 according to the embodiment of the present disclosure may manufacture a meta surface in a highly efficient process. Further, the manufactured meta surface has a high refractive index, which may improve marketability and applicability of products.

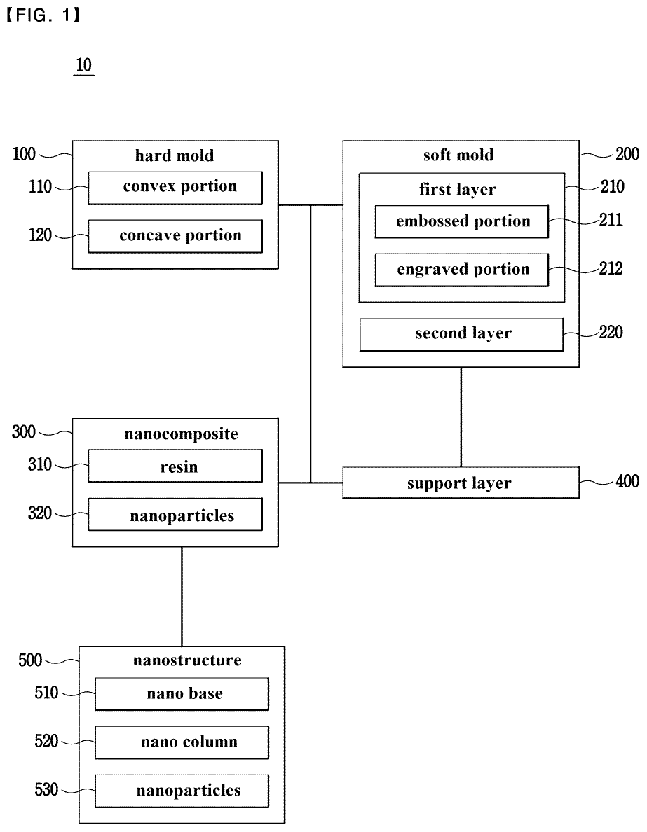

Referring to FIGS. 1 to 3, the meta surface manufacturing apparatus 10 according to the illustrated embodiment comprises a hard mold 100, a soft mold 200, nanocomposites 300, and a support layer 400.

Additionally, for ease of understanding, in the illustrated embodiment, the meta surface manufacturing apparatus 10 is shown to comprise a nanostructure 500. However, it is understood that nanostructure 500 is manufactured by hard mold 100, soft mold 200, nanocomposites 300, and the support layer 400, and is the result of using meta surface manufacturing apparatus 10.

The hard mold 100 is used to manufacture the soft mold 200 for performing printing processes on nanostructure 500. The soft mold 200 may be combined with and stripped from the hard mold 100 by pressing and the like, so that the pattern printed on the hard mold 100 may be replicated on the soft mold 200.

The hard mold 100 is combined with and stripped from the soft mold 200, so that the three-dimensional shape existing on the surface of the hard mold 100 may be provided in any form that may be replicated on the soft mold 200.

As the name suggests, the hard mold 100 is made of a harder material than the soft mold 200. Therefore, even if heat or pressure is applied after the soft mold 200 is combined with the hard mold 100, the shape of the hard mold 100 does not change.

The hard mold 100 may be provided in a plate-like form. The soft mold 200 may be laminated on the plate-like hard mold 100. In the above embodiment, the hard mold 100 and the soft mold 200 may be formed into shapes that correspond to each other.

The hard mold 100 comprises a convex portion 110 and a concave portion 120 formed on one surface facing the soft mold 200. The pattern or design formed by the convex portion 110 and concave portion 120 may be replicated on one surface of the soft mold 200.

The convex portion 110 is a portion that relatively protrudes from the surface of the hard mold 100 toward the soft mold 200. The concave portion 120 is a relatively recessed portion on the surface of the hard mold 100, opposite to soft mold 200. That is, it is understood that the convex portion 110 and the concave portion 120 are relative to each other regarding the direction towards the soft mold 200.

The convex portion 110 and the concave portion 120 may be formed in plurality.

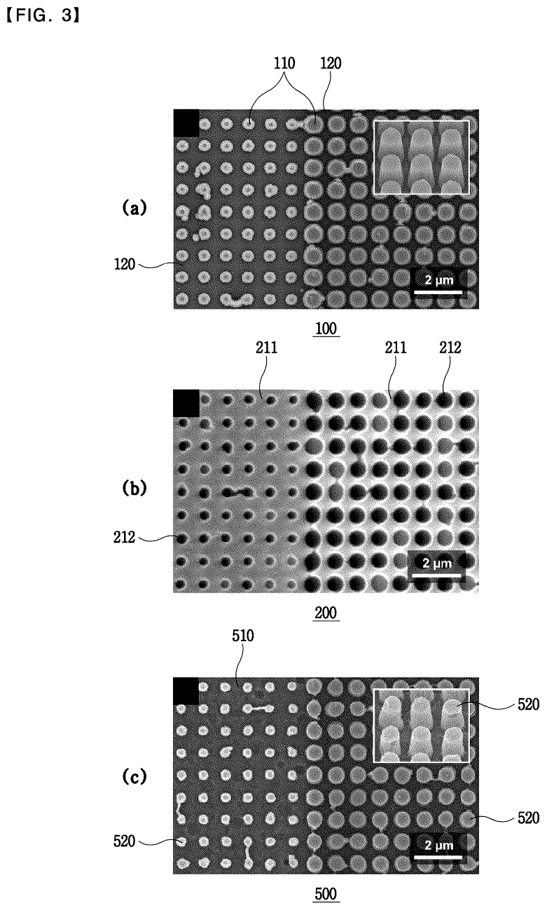

A plurality of convex portions 110 may be arranged on the surface of the hard mold 100 according to a predetermined rule. Referring to (a) of FIG. 3, the plurality of convex portions 110 are arranged side by side and spaced apart from each other by a predetermined distance in the vertical and horizontal directions.

The plurality of convex portions 110 may be formed to have different shapes. In the embodiment illustrated in (a) of FIG. 3, the cross-sectional diameter of the convex portion 110 disposed on the left is smaller than the cross-sectional diameter of the convex portion 110 disposed on the right.

The concave portion 120 is formed between a plurality of convex portions 110. A plurality of concave portions 120 may be arranged on the surface of the hard mold 100 according to a predetermined rule. Referring to (a) of FIG. 3, the plurality of concave portions 120 are arranged between a plurality of convex portions 110 in the vertical and horizontal directions.

That is, on the surface of the hard mold 100, the convex portions 110 and the concave portions 120 are alternatingly arranged along the vertical and horizontal directions. The arrangement of the convex portion 110 and the concave portion 120 forms a predetermined pattern or design on the surface of the hard mold 100.

Accordingly, the predetermined pattern or design formed by the convex portion 110 and the concave portion 120 may be replicated on the surface of the soft mold 200 that is in contact with the surface of the hard mold 100.

The soft mold 200 is in contact with the hard mold 100 and replicates the pattern or design formed on the surface of the hard mold 100, which is the pattern or design formed by convex portion 110 and concave portion 120. The pattern or design may be replicated onto the surface of the soft mold 200 and used to form a nanocomposite 300 into a nanostructure 500.

In other words, the soft mold 200 replicates the pattern or design formed on the hard mold 100 and transfers it to the nanocomposite 300.

The soft mold 200 may be combined with and removed from the hard mold 100 to be provided in any form capable of replicating the pattern or design formed on the surface of the hard mold 100.

In addition, the soft mold 200 may be separably applied on the nanocomposite 300 so that the received pattern or design may be replicated onto the nanocomposite 300.

As the name suggests, the soft mold 200 is made of softer material than the hard mold 100. Therefore, after the soft mold 200 is combined with the hard mold 100, when heat or pressure is applied, the pattern or design of the hard mold 100 may be replicated on the soft mold 200.

The soft mold 200 may be provided in plate-like form. The plate-like soft mold 200 may be laminated on the hard mold 100. As described above, the soft mold 200 may be formed into a shape corresponding to the hard mold 100.

The soft mold 200 may be formed of multiple layers. The plurality of layers may be formed of different materials. Among the plurality of layers, one layer in direct contact with the hard mold 100 may be formed of a material that has relatively low viscosity and high mechanical rigidity compared to the other layers.

In the illustrated embodiment, one layer of the soft mold 200 may be formed of h-PDMS (hard polydimethylsiloxane) material, and the other layer may be formed of PDMS (polydimethylsiloxane) material.

In the illustrated embodiment, soft mold 200 comprises a first layer 210 and a second layer 220.

The first layer 210 may be defined as any one layer among the plurality of layers forming the soft mold 200. The first layer 210 is the layer where the soft mold 200 is combined with the hard mold 100. That is, the first layer 210 may be defined as the layer closest to the hard mold 100 among the plurality of layers forming the soft mold 200.

The first layer 210 replicates the pattern or design formed on the surface of the hard mold 100. The pattern or design formed by the convex portion 110 and the concave portion 120 of the hard mold 100 can be replicated to the surface of the first layer 210.

A nanocomposite 300 is applied on the first layer 210. As will be described later, the nanocomposite 300 is applied on the surface of the first layer 210 on which a pattern or design replicated in the hard mold 100 is formed. Accordingly, the pattern or design formed in the hard mold 100 may be replicated onto the nanostructure 500 formed by the nanocomposite 300.

The first layer 210 is preferably formed of a material with sufficient mechanical rigidity to maintain the pattern or design replicated on the surface of the hard mold 100. Additionally, the first layer 210 is preferably formed of a material with low viscosity so that it can be easily separated from the hard mold 100 and the nanocomposite 300. In an embodiment, the first layer 210 may be formed of h-PDMS (hard polydimethylsiloxane) material.

The surface of the first layer 210, which is in contact with the surface of the hard mold 100 and replicates the pattern or design, is provided with a three-dimensional shape that forms the pattern or design. In the illustrated embodiment, the first layer 210 comprises an embossed portion 211 and an engraved portion 212. The pattern or design formed by the embossed portion 211 and engraved portion 212 may be replicated on the nanocomposite 300.

The embossed portion 211 is a portion which relatively protrudes from the surface of the first layer 210 toward the hard mold 100. The embossed portion 211 is formed by replicating the pattern or design formed by the concave portion 120 of the hard mold 100.

The engraved portion 212 is a relatively depressed portion opposite to the hard mold 100 on the surface of the first layer 210. In other words, the engraved portion 212 is a relatively depressed portion on the surface of the first layer 210 opposite to the nanocomposite 300 applied thereto. The engraved portion 212 is formed by replicating the pattern or design formed by the convex portion 110 of the hard mold 100.

A plurality of embossed portions 211 and engraved portions 212 may be formed.

The plurality of embossed portions 211 are formed between the plurality of engraved portions 212. The plurality of embossed portions 211 may be arranged on the surface of the first layer 210 according to a predetermined rule. Referring to (b) of FIG. 3, the plurality of embossed portions 211 are formed between the plurality of engraved portions 212 in the vertical and horizontal directions, respectively.

The plurality of engraved portions 212 may be arranged on the surface of the first layer 210 according to a predetermined rule. Referring to (b) of FIG. 3, the plurality of engraved portions 212 are arranged side by side and spaced apart from each other by a predetermined distance in the vertical and horizontal directions.

The plurality of engraved portions 212 may be formed to have different shapes. In the embodiment illustrated in (b) of FIG. 3, the cross-sectional diameter of the engraved portion 212 disposed on the left side is smaller than the cross-sectional diameter of the engraved portion 212 disposed on the right side.

That is, on the surface of the first layer 210, the embossed portion 211 and the engraved portion 212 are arranged alternately along the vertical or horizontal directions. The arrangement of the embossed portion 211 and the engraved portion 212 forms a predetermined pattern or design on the surface of the first layer 210.

At this time, it will be understood that the predetermined pattern or design formed on the surface of the first layer 210 is the pattern or design formed on the surface of the hard mold 100 reversed in the vertical direction.

The pattern or design formed on the surface of the first layer 210 is replicated on nanocomposite 300 and implemented in the shape of a nanostructure 500.

The first layer 210 is laminated with the second layer 220. The first layer 210 is supported by the second layer 220.

The second layer 220 may be defined as another layer among the plurality of layers forming the soft mold 200. The second layer 220 supports the first layer 210. That is, the second layer 220 may be defined as a layer spaced apart from the hard mold 100 compared to the first layer 210, among the plurality of layers forming the soft mold 200. Therefore, the second layer 220 is not in direct contact with the hard mold 100.

The second layer 220 is preferably formed of a material with sufficient mechanical rigidity to prevent shape change caused by heat or pressure applied after being combined with the hard mold 100 or nanocomposite 300.

In addition, the second layer 220 is preferably formed of a material with sufficient viscosity to remain combined with the first layer 210 and stably support the first layer 210.

That is, the second layer 220 may be formed of a material with lower mechanical rigidity and higher viscosity than the first layer 210. In an embodiment, the second layer 220 may be formed of polydimethylsiloxane (PDMS) material.

The nanocomposite 300 functions as a medium to replicate the pattern or design replicated on the soft mold 200. The nanocomposite 300 is formed into a three-dimensional shape corresponding to the replicated pattern or design and then cured to form a nanostructure 500 to form a meta surface.

The nanocomposite 300 may be provided in a soft state. That is, the nanocomposite 300 may be transformed in shape by external pressure or heat.

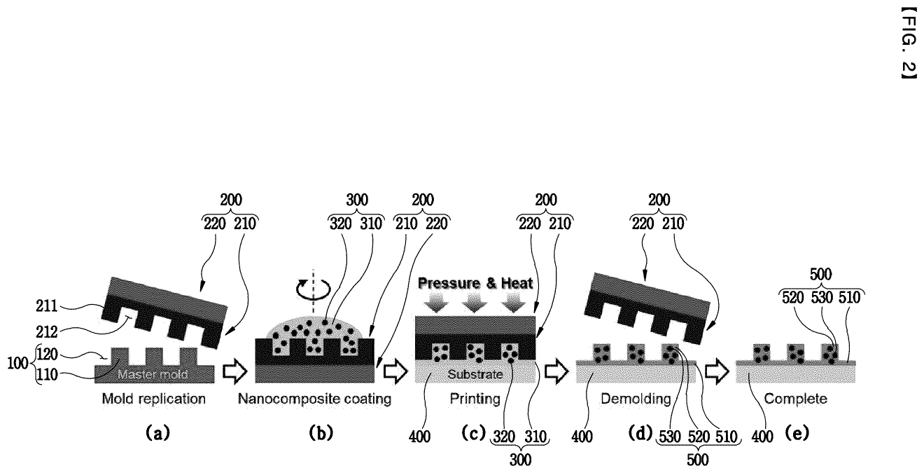

Therefore, the nanocomposite 300 may be evenly applied on the surface of the first layer 210 where the embossed portion 211 and the engraved portion 212 are formed. That is, as shown in (b) of FIG. 2, the nanocomposite 300 may be applied to cover the surface of the first layer 210.

Further, as illustrated in (c) of FIG. 2, the nanocomposite 300 is seated on the support layer 400 and may be evenly introduced into the surface of the first layer 210, especially into the engraved portion 212.

Accordingly, the pattern or design formed on the surface of the hard mold 100 may be replicated onto the nanocomposite 300. Thereafter, when heat or pressure is applied from the outside, the nanocomposite 300 may be cured into a shape-deformed state (i.e., the pattern or design is replicated) to form a nanostructure 500.

In the illustrated embodiment, the nanocomposite 300 comprises resin 310 and nanoparticles 320.

The resin 310 functions as a solvent to accommodate the nanoparticles 320. The resin 310 is formed of a soft material, which is evenly applied on the surface of the first layer 210 and may be deformed in shape by external pressure or heat.

The resin 310 may be formed of a material that can be cured by heat or UV. However, in the embodiment described below in which the nanoparticles 320 are composed of an opaque material, the irradiated UV is scattered by the nanoparticles 320, making it difficult for the resin 310 to be sufficiently cured.

Therefore, in the above embodiment, the resin 310 is preferably formed of a thermosetting material. In an embodiment, resin 310 may be formed of a silicon (Si) material.

The nanoparticles 320 are mixed into the resin 310 and are dispersed and distributed inside the resin 310. The nanoparticles 320 refract the irradiated light, allowing the manufactured meta surface to function as metalens.

The nanoparticles 320 may be formed of any material with a high refractive index for light and a low loss rate of refracted light.

In an embodiment, the nanoparticles 320 may be provided as zirconium dioxide (ZrO2). When the nanoparticles 320 are provided as zirconium dioxide (ZrO2), the subsequent nanostructure 500 comprising them may exhibit a refractive index of 1.8 to 2.0 in the ultraviolet (UV) region, 200 nm to 400 nm, and an extinction coefficient of 0.03 or less. Therefore, the nanostructure 500 described below comprising zirconium dioxide (ZrO2) may operate with high efficiency in the ultraviolet (UV) region.

Additionally, the nanostructure 500 described below comprising zirconium dioxide (ZrO2) may operate in the visible light region.

In another embodiment, the nanoparticles 320 may be provided as titanium dioxide (TiO2).

In another embodiment, the nanoparticles 320 may be provided as silicon (Si).

However, when the nanoparticles 320 are formed of gallium nitride (GaN), the refractive index of the materials is not very high (around 1.9 in the visible light region (wavelength 532 nm)). Therefore, in order to secure a sufficient refractive index, the aspect ratio of the formed nanostructure 500 must be high. This may complicate the manufacturing process, increase manufacturing time, and increase unit costs of the nanostructure 500.

If the nanoparticles 320 are formed of silicon (Si), a high refractive index may be obtained in the infrared region (wavelength 940 nm) as well as in the visible light region. Thus, the refractive index of metalens made of silicon (Si) nanoparticles can be utilized.

Accordingly, the nanoparticles 320 according to an embodiment of the present disclosure are formed of silicon (Si) and may themselves have a high refractive index (more than 2.38 in the visible light region (wavelength 532 nm)).

Thus, even if the aspect ratio of the nanostructure 500 is not increased, a sufficient refractive index can be secured, allowing the nanostructure 500 to be manufactured easily and inexpensively.

As the name suggests, the nanoparticles 320 may comprise particles with diameters in the nanometer unit. For example, the diameter of nanoparticles 320 may be 5 nm to 15 nm, or 10 nm.

The nanoparticles 320 may be provided in plurality. The plurality of nanoparticles 320 may be dispersed and distributed inside the resin 310. Therefore, the nanostructure 500 formed by the nanocomposite 300 may become able to refract light incident at various angles and may be used as a component of the metalens.

The nanocomposite 300 applied on the surface of the first layer 210 is seated on the support layer 400 and heated or pressed.

The support layer 400 supports the nanocomposite 300 so that the nanocomposite 300 replicates the pattern or design formed on the surface of the first layer 210 and maintains the replicated pattern or design until cured.

In the embodiment illustrated in FIGS. 2 (c) and (d), the support layer 400 supports the nanocomposite 300 from the lower side. In other words, the support layer 400 is positioned to face the soft mold 200 with the nanocomposite 300 in between.

In the embodiment illustrated in (e) of FIG. 2, the support layer 400 supports the cured nanostructure 500 from the lower side. That is, the support layer 400 constitutes a portion (lower side in the illustrated embodiment) of the manufactured meta surface.

The support layer 400 may be provided in a plate-like form. The applied nanocomposite 300 and soft mold 200 may be seated on the plate-like support layer 400. In the above embodiment, the support layer 400 may be formed in a shape corresponding to the soft mold 200.

The support layer 400 may be formed of heat-resistant and pressure-resistant materials. As will be described later, this is to prevent shape deformation caused by external pressure or heat applied to cure the seated nanocomposite 300.

The nanostructure 500 is formed by curing the nanocomposite 300 seated on support layer 400 by heat or pressure. The nanostructure 500 comprises the same materials as the nanocomposite 300 but differs from the nanocomposite 300 in that it is hard.

The nanostructure 500 may be formed into a shape corresponding to the pattern or design formed on the surface of the hard mold 100. Additionally, the nanostructure 500 may be formed in a shape that is inverted in the vertical direction with respect to the pattern or design formed on the surface of the first layer 210 of the soft mold 200.

The nanostructure 500 may be seated on the surface of the support layer 400. Further, the nanostructure 500 may be combined with the surface of the support layer 400. Therefore, the nanostructure 500 is not arbitrarily separated from support layer 400.

In the illustrated embodiment, the nanostructure 500 comprises a nano base 510, nano columns 520, and nanoparticles 530.

The nano base 510 forms the bottom of the nanostructure 500. The nano base 510 is where the nanostructure 500 is combined with the support layer 400.

The shape of the nano base 510 may be determined according to the shape of the embossed portion 211 formed on the first layer 210. In the illustrated embodiment, the upper surface of the nano base 510 is formed as a flat surface.

The nano base 510 may be formed into a shape corresponding to the shape of the support layer 400. In the illustrated embodiment, the nano base 510 is provided in a plate shape that covers the support layer 400.

The nano columns 520 extend from the surface of the nano base 510.

The nano columns 520 function as mediums through which irradiated light passes.

The shape of the nano columns 520 may be determined according to the shape of the engraved portion 212 formed in the first layer 210.

The nano columns 520 extend upward in the direction opposite to the nano base 510 illustrated in the embodiment shown in (e) of FIG. 2. The extended length of the nano columns 520 may be equal to the recessed length of the engraved portion 212.

The nano columns 520 may be provided in plurality. The plurality of nano columns 520 may be arranged to be spaced apart from each other. At this time, the plurality of nano columns 520 may be arranged according to a predetermined rule. Additionally, the plurality of nano columns 520 may have cross-sectional diameters that are different from each other.

That is, in the embodiment illustrated in (c) of FIG. 3, the plurality of nano columns 520 are spaced apart from each other along the vertical and horizontal directions, in other words, are arranged in a grid shape. Further, the cross-sectional diameter of the nano column 520 disposed on the left is formed to be larger than the cross-sectional diameter of the nano column 520 disposed on the right.

It will be understood that the shape and arrangement method of the nano column 520 may change depending on the shape of the surface of the first layer 210 and the shape of the surface of the hard mold 100.

Nanoparticles 530 refract light irradiated into the interior of the nanostructure 500.

Nanoparticles 530 are identical in material and shape to the nanoparticles 320 provided in the nanocomposite 300 described above.

In an embodiment, nanoparticles 530 comprised in the nanostructure 500 may be zirconium dioxide (ZrO2).

The nanostructure 500 comprising nanoparticles 530 which are zirconium dioxide (ZrO2), may exhibit a refractive index of 1.8 to 2.0 and an extinction coefficient of 0.03 or less in the ultraviolet (UV) region of 200 nm to 400 nm. Thus, if ultraviolet (UV) light is transmitted through the nanostructure 500 comprising zirconium dioxide (ZrO2), the length of the nano column 520 may not increase excessively, as it exhibits a high refractive index and a low extinction coefficient.

In another embodiment, the nanoparticles 530 comprised in the nanostructure 500 may be titanium dioxide (TiO2).

The nano columns 520 of the nanostructure 500 may be provided in one of the following geometries: rectangular parallelepiped, cylindrical, or ellipsoidal.

For example, if the nano column 520 is provided in a rectangular parallelepiped shape, the nano column 520 may be provided with a length of 50 nm to 90 nm (preferably 70 nm) on one side, a length of 200 nm to 300 nm (preferably 250 nm) on the other side, and a height of 700 to 800 nm (preferably 760 nm). Additionally, the interval (period) between the centers of the plurality of nano columns 520 may be 250 nm to 350 nm (preferably 300 nm).

Additionally, when an ultraviolet (UV) ray is irradiated on the nanostructure, the transmission efficiency may be 80% or more. For example, when an ultraviolet ray (UV) is transmitted through the nanostructure 500 manufactured with nano columns 520 with the size described above, the transmission efficiency may be 84.5%.

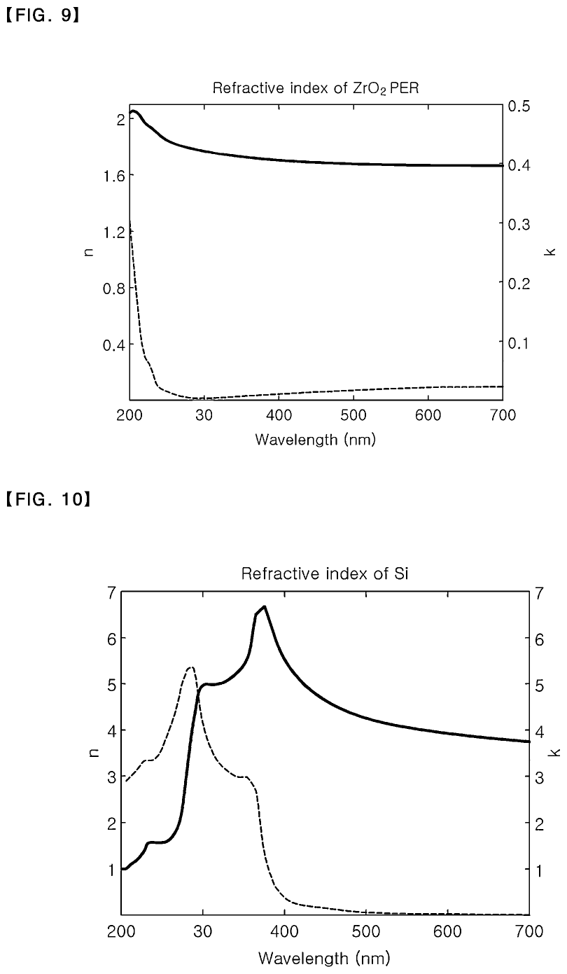

FIG. 9 is a graph showing the refractive index and extinction coefficient according to the wavelength of the light transmitting through when the nanoparticles 530 of the nanostructure 500 are zirconium dioxide (ZrO2).

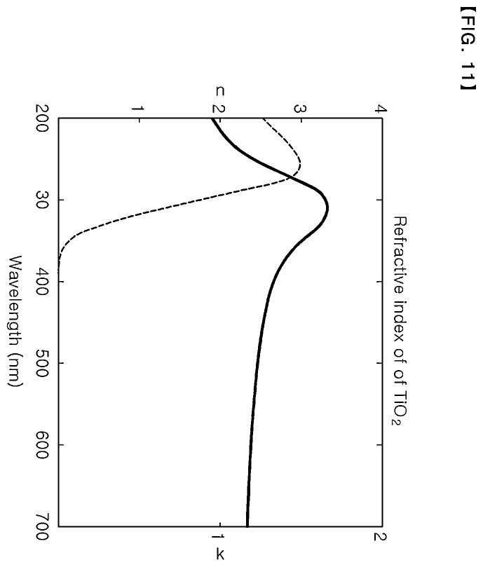

FIG. 10 is a graph showing the refractive index and extinction coefficient according to the wavelength of light transmitting through when the nanoparticles 530 of nanostructure 500 are silicon (Si).

FIG. 11 is a graph showing the refractive index and extinction coefficient according to the wavelength of the light transmitting through when the nanoparticles 530 of the nanostructure 500 are titanium dioxide (TiO2).

Referring to FIGS. 9 to 11, it can be seen that the refractive index in the ultraviolet (UV) region is higher and the extinction coefficient is lower when the nanoparticles 530 are provided as zirconium dioxide ZrO particles than when the nanoparticles 320 are provided as silicon (Si) particles or titanium dioxide TiO particles.

That is, when the nanoparticles 530 are formed into zirconium dioxide (ZrO2) particles, the nanostructure 500 may operate with high efficiency even in the ultraviolet (UV) region. Here, the solid lines illustrated in FIGS. 9 to 11 represent the refractive indices, and the broken lines represent the extinction coefficients.

Additionally, the range of refractive index of the nanostructure 500 may be controlled by adjusting the amount of the nanoparticles 530.

In another embodiment, nanoparticles 530 may be made of silicon (Si), which has a high refractive index for light (about 2.38). In this case, even if the extension length of the nano column 520 is not excessively increased, light can be sufficiently refracted by the nanoparticles 530.

Therefore, the efficiency and economic feasibility of the process for manufacturing nanostructure 500 and the meta surface comprising the same may be improved. Furthermore, the efficiency and economic feasibility of the process for manufacturing metalens using the manufactured meta surface as an element may also be improved.

### 3. Description of the Metasurface Manufacturing Method According to the Embodiment of the Present Disclosure

The meta surface manufacturing method according to the embodiment of the present disclosure may manufacture the nanostructure 500 using the nanocomposite 300 through each element of the meta surface manufacturing apparatus 10 described above. At this time, the nanostructure 500 may be manufactured through a quick and inexpensive process.

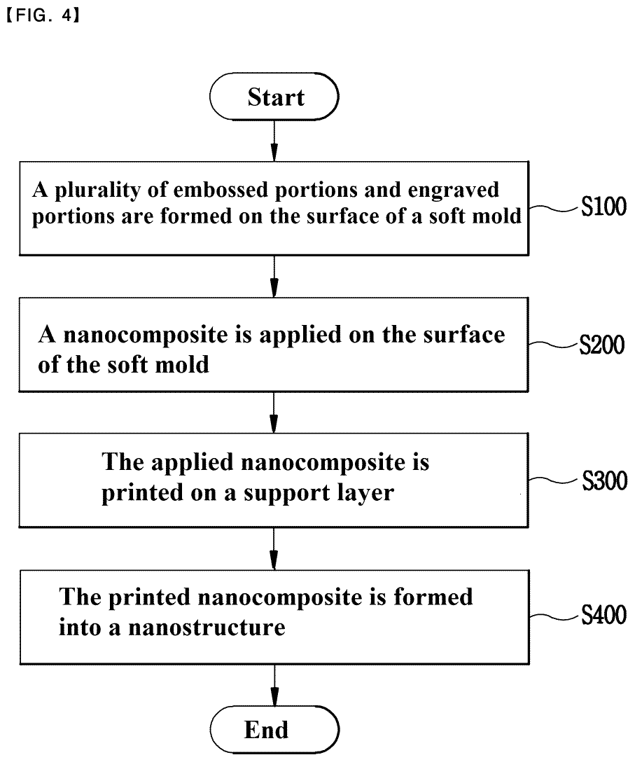

Hereinafter, a meta surface manufacturing method according to the illustrated embodiment will be described in detail with reference to FIGS. 4 to 8.

In the illustrated embodiment, the meta surface manufacturing method comprises a step in which a plurality of embossed portions 211 and engraved portions 212 are formed on the surface of the soft mold 200 (S100), a step in which nanocomposite 300 is applied to the surface of the soft mold 200 (S200), a step in which the applied nanocomposite 300 is printed on the support layer 400 (S300) and a step in which the printed nanocomposite 300 is formed into the nanostructure 500 (S400).

(1) Description of the Step (S100) in which a Plurality of Embossed Portions 211 and Engraved Portions 212 are Formed on the Surface of the Soft Mold 200.

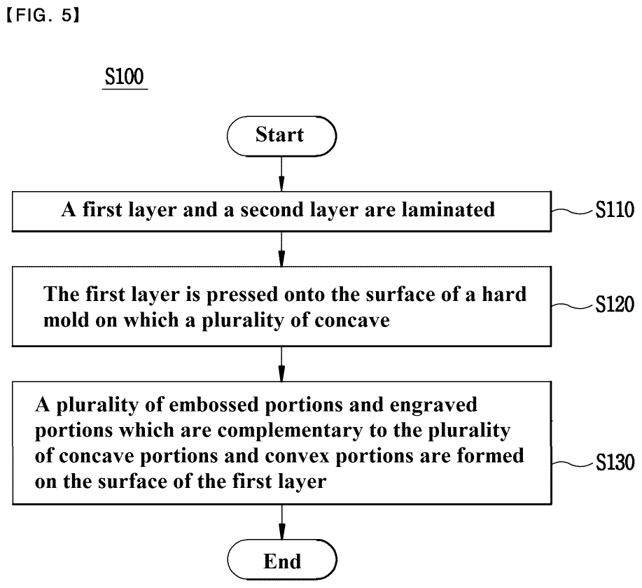

This is the step (S100) in which a pattern or design in the shape of the nanostructure 500 is formed on the surface of the first layer 210 of the soft mold 200. Hereinafter, the present step (S100) will be described in detail with reference to FIG. 5.

First, a soft mold 200 is formed. To this end, the first layer 210 and the second layer 220 are sequentially laminated (S110).

The first layer 210, which is in direct contact with the hard mold 100 and the nanocomposite 300, may be formed of h-PDMS (hard polydimethylsiloxane) material with relatively high mechanical rigidity and low viscosity.

The second layer 220, which is not in direct contact with the hard mold 100 and the nanocomposite 300 and supports the first layer 210, may be formed of PDMS (polydimethylsiloxane) material with relatively low mechanical rigidity and high viscosity.

Next, the first layer 210 is pressed onto the surface of the hard mold 100 in which a plurality of convex portion and concave portions 120 are formed (S120). That is, the soft mold 200 is seated on the surface of the hard mold 100.

Accordingly, a plurality of embossed portions 211 and engraved portions 212 which are complementary to the plurality of convex portions 110 and concave portions 120 formed on the surface of the hard mold 100 are formed on the surface of the first layer 210 (S130).

That is, the plurality of embossed portions 211 and engraved portions 212 formed on the surface of the first layer 210 are formed opposite to the plurality of convex portions 110 and concave portions 120 formed on the surface of the hard mold 100.

When the plurality of embossed portions 211 and engraved portions 212 are formed on the surface of the first layer 210, the soft mold 200 is removed from the hard mold 100.

(2) Description of the Step (S200) in which Nanocomposite 300 is Applied on the Surface of a Soft Mold 200

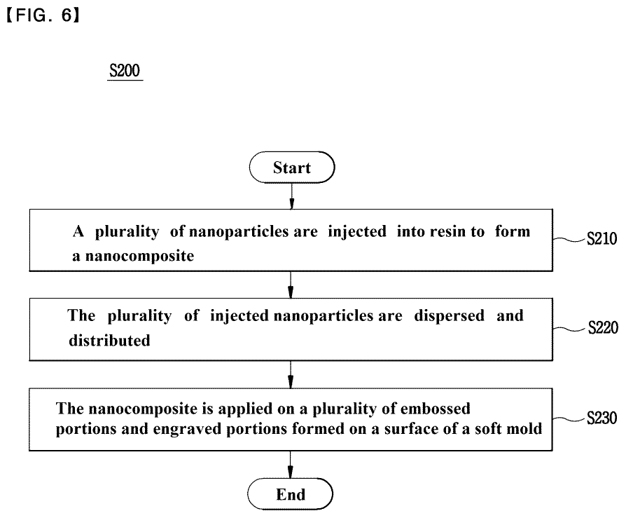

This is a step (S200) in which nanocomposite 300 is applied on the surface of a soft mold 200 on which a pattern or design is formed by a plurality of embossed portions 211 and engraved portion 212. Hereinafter, the present step (S200) will be described in detail with reference to FIG. 6.

First, a nanocomposite 300 is formed (S210). In specific, a plurality of nanoparticles 320 are injected into a soft resin 310 to form the nanocomposite 300.

At this time, as described above, the nanoparticles 320 may be zirconium dioxide (ZrO2), and the resin 310 may be silicon (Si).

Additionally, in another embodiment, the nanoparticles 320 may be provided as titanium dioxide (TiO2).

In another embodiment, the nanoparticles 320 may be a silicon (Si) material.

The plurality of nanoparticles 320 injected into the resin 310 are dispersed and distributed (S220). Therefore, the plurality of nanoparticles 320 may be evenly distributed throughout the interior of the resin 310. Accordingly, light incident on the completed nanostructure 500 at various angles may be effectively refracted.

The manufactured nanocomposite 300 is applied on the surface of the first layer 210 of the soft mold 200 (S230). That is, the nanocomposite 300 is applied on the plurality of embossed portions 211 and engraved portions 212 formed on the surface of the first layer 210. At this time, the nanocomposite 300 may be applied evenly and densely on the plurality of embossed portions 211 and engraved portions 212.

Therefore, it will be understood that when this step (S200) is completed, the nanocomposite 300 will be in a state of covering the first layer 210 of the soft mold 200.

(3) Description of a Step (S300) in which the Applied Nanocomposite 300 is Printed on Support Layer 400

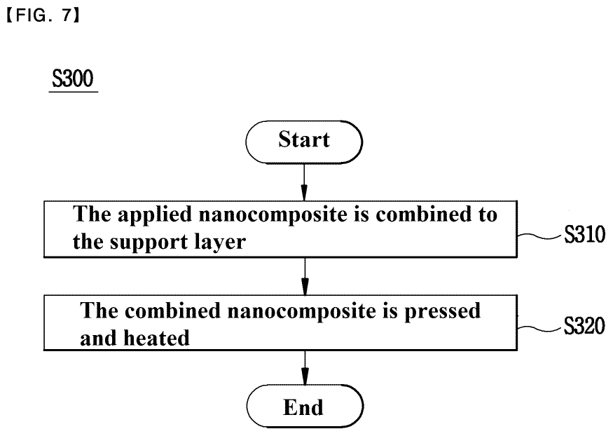

This is a step (S300) in which the pattern or design formed on the surface of the soft mold 200 is replicated (i.e., printed) on the nanocomposite 300 applied on the surface of the soft mold 200. Hereinafter, the present step will be described in detail with reference to FIG. 7.

The applied nanocomposite 300 is combined with the support layer 400 (S310). In specific, the soft mold 200 comprising the first layer 210 with the nanocomposite 300 applied on its surface is seated on the support layer 400. Therefore, the surface of the support layer 400 and the surface of the first layer 210 face each other with the applied nanocomposite 300 in between.

Next, the nanocomposite 300 is heated or pressed (S320). At this time, the nanocomposite 300 remains combined with the first layer 210, so it is cured while maintaining the shape corresponding to the pattern or design formed in the first layer 210.

Accordingly, when this step (S300) is completed, the nanocomposite 300 may be printed in a shape corresponding to the pattern or design formed on the surface of the hard mold 100 and the surface of the soft mold 200.

(4) Step in which the Printed Nanocomposite 300 is Formed into the Nanostructure 500 (S400)

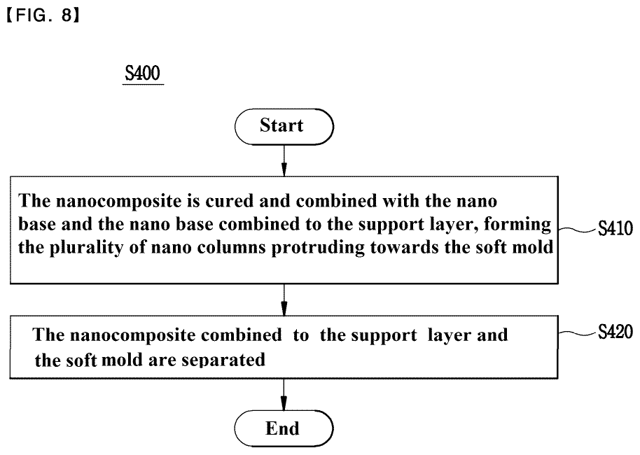

This is a step (S400) in which the nanocomposite 300 with a pattern or design printed on the surface of soft mold 200 is cured and the nanostructure 500 is formed. Hereinafter, the present step will be described in detail with reference to FIG. 8.

First, the nanocomposite 300 is cured (S410). The nanocomposite 300 may be cured by pressing or heating. As described above, the nanocomposite 300 has a shape corresponding to the pattern or design formed on the surface of the soft mold 200 printed on it.

Accordingly, the cured nanocomposite 300 is combined with the nano base 510 and the nano base 510 combined to the support layer 400, and a plurality of nano columns 520 protruding toward the soft mold 200 are formed.

At this time, the structure, number, and arrangement method of the plurality of nano columns 520 may be determined by the pattern or design formed on the surface of the soft mold 200.

Next, the soft mold 200 combined with the nanocomposite 300 (i.e., nanostructure 500) is separated (S420). Accordingly, the lower side of the nanostructure 500 is supported by the support layer 400, and the nano column 520 extends in a direction opposite to the support layer 400.

Thus, after the present step (S400) is completed, a meta surface may be manufactured by the nanostructure 500 combined to the support layer 400.

### 4. Description of the Meta Surface Manufactured by the Meta Surface Manufacturing Apparatus 10 or Meta Surface Manufacturing Method According to the Embodiment of the Present Disclosure

According to the meta surface manufacturing apparatus 10 and the meta surface manufacturing method according to the embodiment of the present disclosure, a high refractive index may be secured even if the length of the nano column 520 of the manufactured nanostructure 500 is not excessively increased.

Accordingly, the manufacturing process of the meta surface and nanostructure 500 for manufacturing the same may become easier, and as a result, the efficiency and economic feasibility of the manufacturing process may be improved.

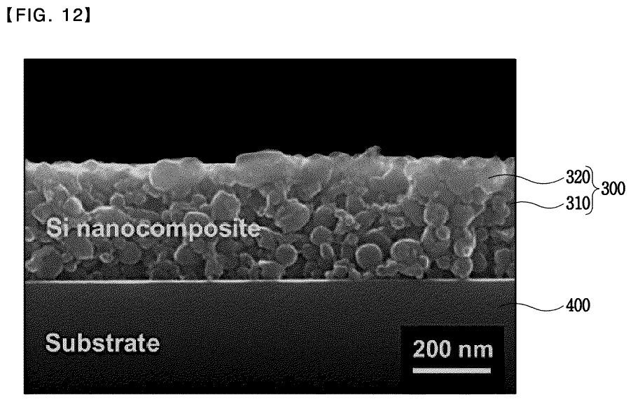

Hereinafter, with reference to FIGS. 12 to 23, the nanostructure 500 manufactured by the meta surface manufacturing apparatus 10 and the meta surface manufacturing method according to the embodiment of the present disclosure and the meta surface manufactured using the same will be described in detail.

Referring to FIG. 12, a support layer 400 and a nanocomposite 300 seated in the support layer 400 according to an embodiment of the present disclosure are illustrated.

As described above, a plurality of nanoparticles 320 are dispersed and distributed inside the resin 310. In an embodiment, a plurality of nanoparticles 320 may be evenly distributed.

At this time, the resin 310 may be formed of silicon (Si), and the nanoparticles 320 may be formed of silicon (Si) or titanium dioxide (TiO2).

FIG. 12 illustrates nanoparticles 320 provided as an example of these materials, but this is intended to be exemplary and may be provided as zirconium dioxide (ZrO2), or titanium dioxide (TiO2) instead of silicon (Si).

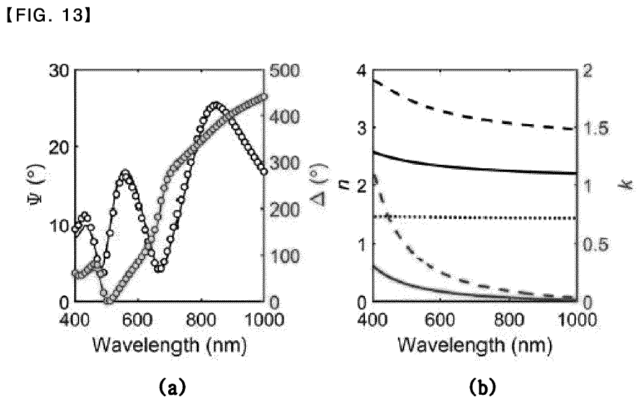

Referring to FIG. 13, among various properties of the nanocomposite 300, a graph of polarization change, refractive index (n), and extinction coefficient (k) is illustrated.

The horizontal axis of each graph is the wavelength (nm), and the vertical axis of FIG. 13 (a) is the amplitude component (Ψ) (°) (left) and phase difference (Δ)) (°) (right)) am. Additionally, the vertical axis of FIG. 10 (b) represents the refractive index (n) (left) and extinction coefficient (k) (right).

Among the graphs illustrated in (a) of FIG. 13, the graph extending from the lower left to the upper right is a graph of the phase difference (Δ), and the graph extending in a waveform is a graph of the amplitude component (Ψ). In addition, the solid line is the measured data, and the circle is the fitted result using the Maxwell-Garnett Model.

In the above graph, the volume fraction of silicon (Si) nanoparticles 320 to nanocomposite 300 was measured to be 58.6%, and the mean square error between the measured data and the fitted result was 23.426, indicating that the result of the measured data is reliable.

Among the graphs illustrated in (b) of FIG. 13, the solid and broken lines disposed on the upper side are graphs for the extinction coefficient (k), and the solid and broken lines disposed on the lower side are graphs for the refractive index (n). Additionally, the solid line is data for silicon (Si) nanoparticles 320, the broken line is data for nanoparticles 320, and the dotted line is data for resin 310.

The graph shows that the nanocomposite 300 according to the embodiment of the present disclosure exceeds the refractive index (n) of 2.2, which is an indicator of high efficiency NIR (Near Infrared Spectrometry) metalens.

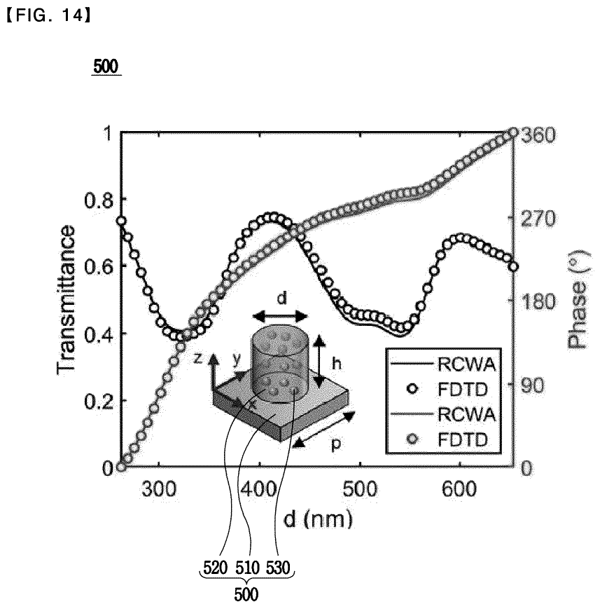

Referring to FIG. 14, a graph is illustrated showing the transmittance of light incident on the nanostructure 500 and the phase of the nano column 520 under the condition that the wavelength (%) is 940 nm.

The data was acquired using Rigorous Coupled-Wave Analysis (RCWA) and Finite-Difference Time-Domain (FDTD) methods.

In the above graph, the horizontal axis is the diameter (d) of the nano column 520, the vertical axis on the left is the transmittance, and the vertical axis on the right is the phase) (°) of the nano column 520.

The diameter of the nano column 520 varies between 260 nm and 650 nm, the height of the nano column 520 is 1.2 μm, and the width (p) of the nano base 510 is 900 nm.

Among the graphs, the graph extending from the lower left to the upper right is a graph for phase) (°), and the graph extending in a waveform is a graph for transmittance.

Therefore, the graph shows that the transmittance and phase) (°) may be regulated by adjusting the shape of nanostructure 500.

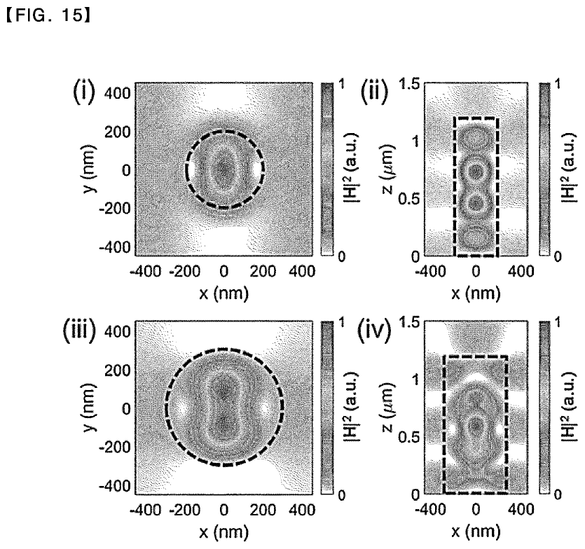

Referring to FIG. 15, the simulated magnetic field intensity (| Hvert²) is shown under the condition that the wavelength (λ) is 940 nm. The black broken line is the outline of each structure, the horizontal axis is the X-axis position, and the vertical axes are the Y-axis position and Z-axis position, respectively.

Graphs (i) and (ii) are under the condition that the diameter (d) of the nano column 520 is 400 nm, and graphs (iii) and (iv) are under the condition that the diameter of the nano column 520 is 600 nm.

The graph shows that due to the high refractive index of the nanostructure 500, the electromagnetic field formed is maintained inside the nanostructure 500.

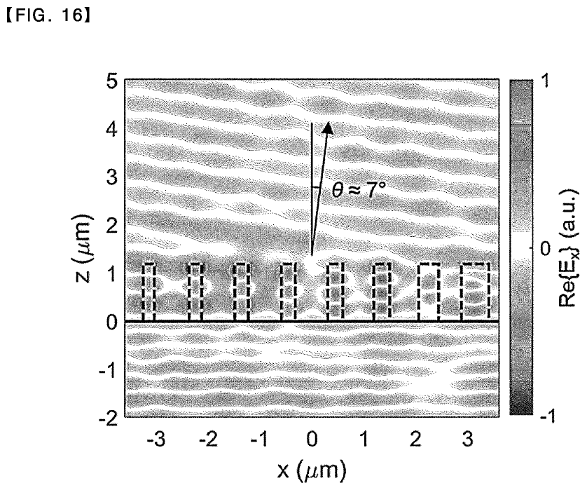

Referring to FIG. 16, the results of beam-steering simulation to confirm the phase change per unit nano column 520 under the condition that the wavelength (λ) is 940 nm are illustrated. The horizontal axis is the X-axis position, and the vertical axis is the Z-axis position.

The diameter of the nano column 520 in the direction from left to right changes to 262, 288, 306, 324, 352, 396, 464, and 586 nm, and the polar angle (⊖) of 7° corresponds to the phase change calculated for the nano column 520.

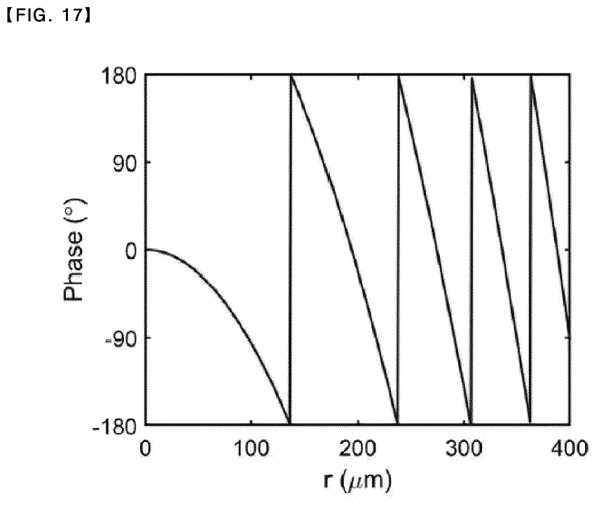

Referring to FIG. 17, a graph for the phase of the space required for a metal lens with a focal length of 2 cm is illustrated under the condition that the wavelength (λ) is 940 nm. The horizontal axis r is the distance of emission direction (μm) from the center of the metal lens.

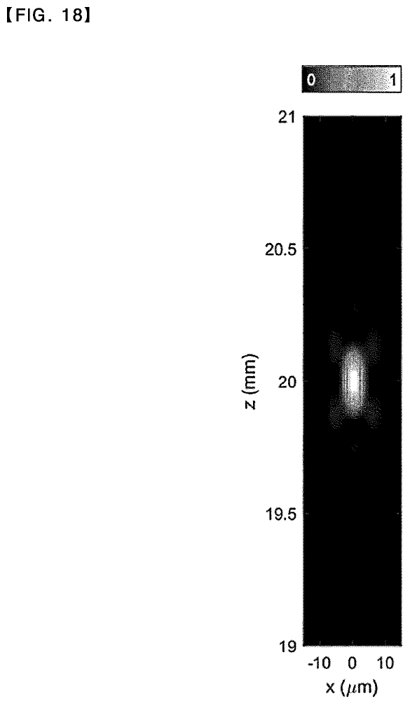

Referring to FIG. 18, a graph of the intensity of the optical field of light passing through the designed metalens is illustrated. In the above graph, the horizontal axis is the X-axis position, and the vertical axis is the Z-axis position.

The graph shows that the incident light is concentrated at the intended location which is the Z-axis position of 2 mm.

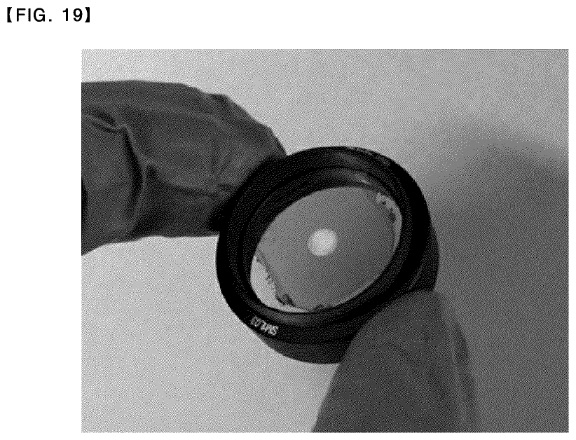

FIG. 19 is a use state diagram illustrating metalens equipped with a meta surface manufactured by the meta surface manufacturing apparatus 10 and the meta surface manufacturing method according to an embodiment of the present disclosure. The diameter of the metalens (circled inside) is 4 mm, and the diameter of the lens tube to which the metalens are mounted is 1 inch.

As described above, the meta surface according to the embodiment of the present disclosure may be manufactured using the nanostructure 500 manufactured through the soft mold 200 with a plurality of layers.

Accordingly, since the soft mold 200 is flexible and reusable, the efficiency and economic feasibility of the manufacturing process of the illustrated metalens and lens tube comprising the same may be improved.

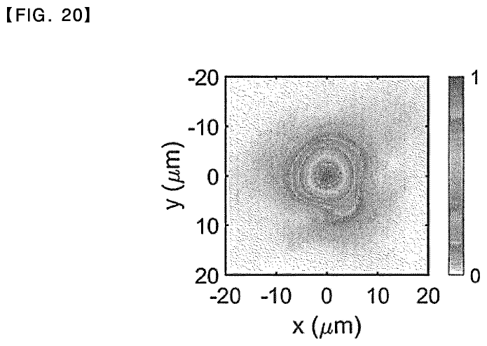

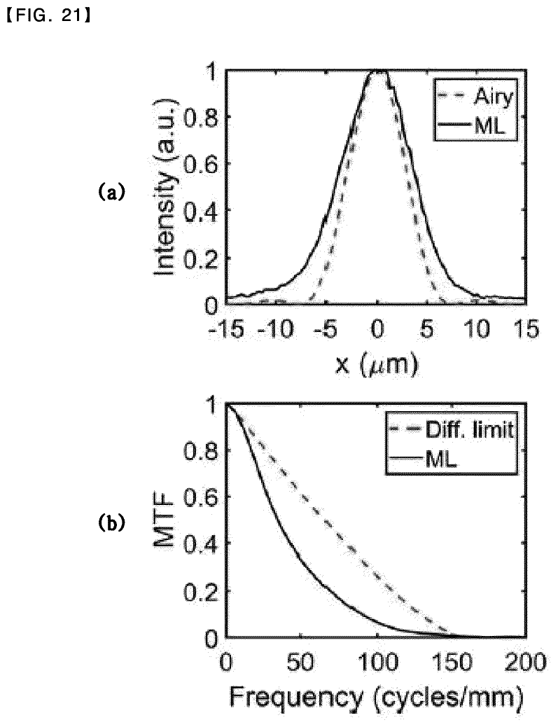

Referring to FIGS. 20 and 21, optical characterization of metalens manufactured using the nanostructure 500 is illustrated.

Referring to FIG. 20, an image of the focus created by the metalens is shown. The horizontal axis is the X-axis position, and the vertical axis is the Y-axis position. In the graph, it can be seen that the generated image of focus becomes stronger toward the center of nano column 520 in the horizontal direction.

Referring to (a) of FIG. 21, the cross-sectional intensity profile at the center of the focus is illustrated. The horizontal axis represents the X-axis position, and the vertical axis represents intensity.

In case of the Airy disk indicated with a broken line, the half-maximum width is 6.3 μm, and for metalens (ML), the half-maximum width is 8.1 μm, which is longer than that of the Airy disk.

Referring to (b) of FIG. 21, a comparison results of the modulation transfer function of the metalens (ML) and the diffraction limited modulation transfer functions (MTF) is illustrated. The horizontal axis represents frequency (cycles/mm), and the vertical axis represents modulation transfer function (MTF).

The frequency of the MTF of the metalens (ML), illustrated as a solid line, reaches the diffraction limited cutoff frequency.

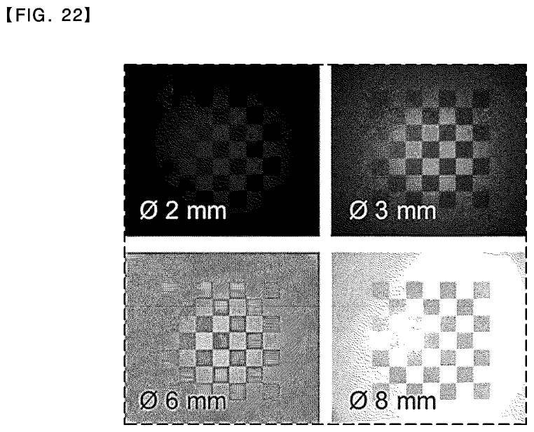

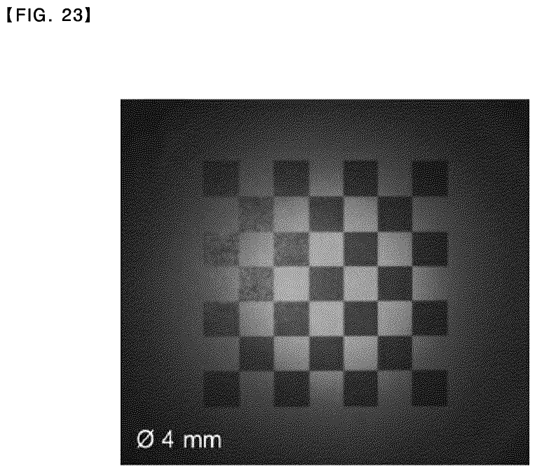

Referring to FIGS. 22 and 23, imaging results by an NIR camera to which a meta surface manufactured by the meta surface manufacturing apparatus 10 and the meta surface manufacturing method according to an embodiment of the present disclosure are applied are illustrated.

Referring to FIG. 22, the generated image according to the aperture diameter (φ) is shown. It can be seen that as the aperture diameter (φ) increases, the brightness of the generated image increases. Additionally, the contrast of the generated image is maximized when the aperture diameter (φ) is equal to the area of the metalens.

Referring to FIG. 23, an example is illustrated in which the contrast difference is maximized when the aperture diameter (φ) is equal to the area of the metalens (4 mm).

Although the description has been made with reference to preferred embodiments of the present disclosure, those skilled in the art may modify the present disclosure in various ways without departing from the technical idea and scope of the present disclosure as set forth in the claims below.

### INDUSTRIAL APPLICABILITY

The meta surface manufacturing apparatus, manufacturing method, and meta surface of the present disclosure are available for industrial use.

What is claimed is:

1. A meta surface manufacturing apparatus comprising a soft mold with a surface on which a plurality of embossed portions and engraved portions are formed; and a nanocomposite applied on the surface of the soft mold, wherein the nanocomposite comprises:
resin formed from thermosetting material; and
nanoparticles mixed in the resin, wherein the nanoparticles are provided in one of the following materials: zirconium dioxide (ZrO2), silicon (Si), and titanium dioxide (TiO2).

2. The meta surface manufacturing apparatus of claim 1, wherein the soft mold comprises:
a first layer which forms the surface and where the nanocomposite is applied; and
a second layer coupled to the first layer and disposed opposite to the surface;
wherein a material forming the first layer is less viscous and more rigid than a material forming the second layer.

3. The meta surface manufacturing apparatus of claim 2, wherein the first layer is formed with h-PDMS (hard polydimethylsiloxane) material,
and the second layer is formed with polydimethylsiloxane (PDMS) material.

4. The meta surface manufacturing apparatus of claim 1 comprises:
a hard mold with a surface on which the plurality of concave portions and the convex portions disposed complementary to the plurality of embossed portions and engraved portions are formed; and
the plurality of embossed portions and engraved portions formed on the surface of the soft mold are formed by the plurality of convex portions and concave portions formed on the surface of the hard mold through replicating.

5. The meta surface manufacturing apparatus of claim 1 comprising a support layer which is in contact with the surface of the soft mold and in which the nanocomposite applied on the surface of the soft mold is seated.

6. A meta surface manufactured according to any one of claims 1 to 5, comprising a nanostructure formed by curing the nanocomposite.

7. The meta surface of claim 6, wherein the nanostructure comprises:
a nano base forming the base of the nanostructure and formed in a plate-like form; and
nano columns protruding from the nano base.

8. The meta surface of claim 7, wherein the nano columns are provided in a plurality, and the plurality of the nano columns are spaced apart from each other.

9. A meta surface manufacturing method comprising:
a step (a) in which a plurality of embossed portions and engraved portions are formed on the surface of a soft mold;
a step (b) in which nanocomposite is applied onto the surface of the soft mold;
a step (c) in which the applied nanocomposite is printed on a support layer; and
a step (d) in which the printed nanocomposite is formed into a nanostructure,
wherein the nanostructure comprises resin formed of thermosetting material; and nanoparticles mixed in the resin, wherein the nanoparticles are provided in one of zirconium dioxide (ZrO2), silicon (Si), and titanium dioxide (TiO2).

10. The meta surface manufacturing method of claim 9, wherein the step (a) comprises:
a step (a1) in which a first layer and a second layer are laminated;
a step (a2) in which the first layer is pressed onto a hard mold; and
a step (a3) in which the plurality of embossed portions and engraved portions are formed on the surface of the first layer complementary to the plurality of concave portions and convex portions.

11. The meta surface manufacturing method of claim 9, wherein the step (b) comprises:
a step (b1) in which the plurality of nanoparticles are injected into the resin to form the nanocomposite;
a step (b2) in which the injected nanoparticles are dispersed and distributed; and
a step (b3) in which the nanocomposite is applied on the plurality of embossed portions and engraved portions formed on the surface of the soft mold.

12. The meta surface manufacturing method of claim 9, wherein the step (c) comprises:
a step (c1) in which the nanocomposite is combined with the support layer; and
a step (c2) in which the combined nanocomposite is pressured and heated.

13. The meta surface manufacturing method of claim 9, wherein the step (d) comprises:
a step (d1) in which the combined nanocomposite is cured and forms a nano base combined with the support layer, and a plurality of nano columns protruding towards the soft mold; and
a step (d2) in which the nanocomposite combined to the support layer and the nanocomposite are separated.
